(19) United States
(12) Patent Application Publication
(10) Pub. No.: US 2023/0356323 A1
(43) Pub. Date: Nov. 9, 2023

(54) BATTERY POWERED CNC LASER MARKER WITH BUILT-IN MOTION SENSOR

(71) Applicant: Panasonic Corporation of North America, Newark, NJ (US)

(72) Inventors: Riccardo Leto, Arlington, MA (US); Carlton Brule, Boston, MA (US)

(21) Appl. No.: 17/983,730

(22) Filed: Nov. 9, 2022

Related U.S. Application Data
(60) Provisional application No. 63/338,488, filed on May 5, 2022.

(51) Int. Cl. B23K 26/03; B23K 26/362; B23Q 33/00

(52) U.S. Cl. CPC B23K 26/03; B23K 26/362; B23Q 33/00; B23Q 2735/002

(57) ABSTRACT

A laser marking tool for use with a CNC machine is disclosed. The laser marking tool includes a housing; a laser disposed within the housing; at least one sensor disposed within the housing and adapted to interpret a predetermined motion of the CNC machine as a command for the tool to perform a respective predetermined function; and a power source coupled to the laser. The at least one senor is an accelerometer and/or a gyroscope. The respective predetermined function comprises one or more of: powering the laser off/on, synchronizing the laser marking tool, and loading one of the patterns stored in a local memory.

### CROSS REFERENCE TO RELATED APPLICATIONS

This application claims priority from U.S. Provisional Application Ser. No. 63/338,488, titled “Battery Powered CNC Laser Marker With Built-In Motion Sensor,” filed May 5, 2022, incorporated herein by reference in its entirety.

### FIELD OF THE INVENTION

The present invention relates to Computational Numerical Control (CNC) machining tools for marking of workpieces, and more specifically a battery-powered CNC laser marker with a built-in motion sensor.

### BACKGROUND OF THE INVENTION

CNC tools are used for milling or drilling, so there is no need for active control by the CNC machine. Thus, CNC tools are generally passive, apart from certain exceptions (i.e. active tools), including the alignment tool. The alignment tool is used to find reference points on a workpiece, and so needs to wirelessly communicate with the CNC machine. To address this need, an external transmitter is connected to a digital output on the CNC machine. The external transmitter relays the signal to the active tool using some form of wireless communication (e.g., infrared (IR) technology, Bluetooth®, WiFi, etc.). Because both systems (the CNC machine and the active tool) are generally “closed” (i.e. no hardware or software interface available), active tools are manufactured in conformity with the technical requirements of specific CNC machines and cannot easily be deployed on other CNC machines from other manufacturers or older models without incurring expenses and/or inconvenience.

Thus, battery-powered laser marker having a built-in motion sensor for use in a CNC machine are desired for improving laser marking of CNC machined parts, particularly as compared to utilizing standard passive CNC tools.

### SUMMARY OF THE INVENTION

Aspects of the present invention are directed to laser machining systems and manufacturing apparatuses or methods. More particularly, the present invention relates to a CNC machine with a battery-powered laser marker having a built-in motion sensor.

In accordance with one aspect of the present invention, a laser marking tool for use with a CNC machine is disclosed. The laser marking tool comprises a housing; a laser disposed within the housing; at least one sensor disposed within the housing and adapted to interpret a predetermined motion of the CNC machine as a command for the tool to perform a respective predetermined function; and a power source coupled to the laser.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale unless otherwise indicated. On the contrary, the dimensions of the various features may be expanded or reduced for clarity. Included in the drawings are the following figures:

FIG. 1 depicts an exemplary system comprising a laser marking tool and a CNC machine in accordance with an embodiment of the invention;

FIG. 2 depicts an exemplary laser marking tool of FIG. 1;

FIGS. 3A-3B depict an exemplary tool adapter of the wireless laser marking tool of FIG. 2;

FIG. 4 depicts an exemplary laser operation of the laser marking tool of FIG. 2;

FIGS. 5A-5C depict another exemplary laser operation of the laser marking tool of FIG. 2;

FIG. 6 depicts another exemplary laser operation of the laser marking tool of FIG. 2; and

FIG. 7 depicts another exemplary laser marking tool in accordance with an embodiment of the invention.

### DETAILED DESCRIPTION OF INVENTION

Aspects of the invention are described herein with reference to a laser marking tool for use in a CNC machine. However, it will be understood by one of ordinary skill in the art that the exemplary tools described herein are not limited to a laser marking tool for use with a CNC machine, but may be applicable to other known CNC tools or similar devices.

The terms “workpiece” and “parts” (e.g. machined parts) as described herein and throughout the specification may encompass a variety of components formed (by a CNC machine) from a block of raw material, including but not limited to steel, aluminum, Inconel, titanium, Chrome-Molybdenum-Vanadium (CMV). Non-limiting examples of machined parts include a turbine, motor shaft, splines, etc. Likewise, the term “information” as described herein and throughout the specification may encompass a variety of data which may be useful for traceability of machined parts or required for a serialization process. However, laser marking is not limited to functional purposes (e.g. a QR code for providing date of manufacture, material bath, machinist, engineer, etc.), and may be additionally or optionally used for aesthetic marking, including but not limited to, artistic designs such as logos, text, images, layout patterns, etc. Still further, the term “marking” encompasses 2D cutouts, which could be used to make 3D structures, used as templates, or other applications. It should also be understood that laser marking is not limited to certain industries, which may include high value, high security industries such as aerospace and healthcare.

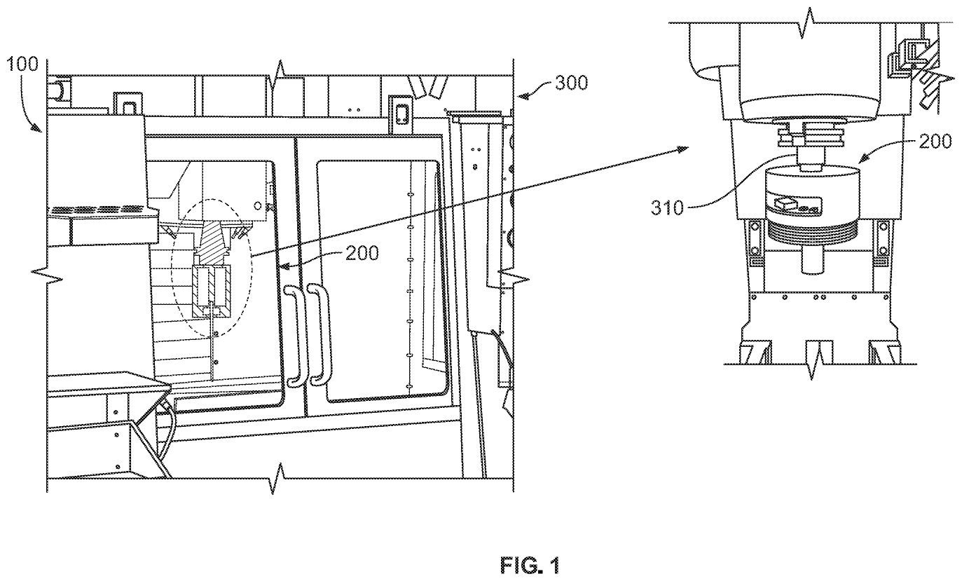

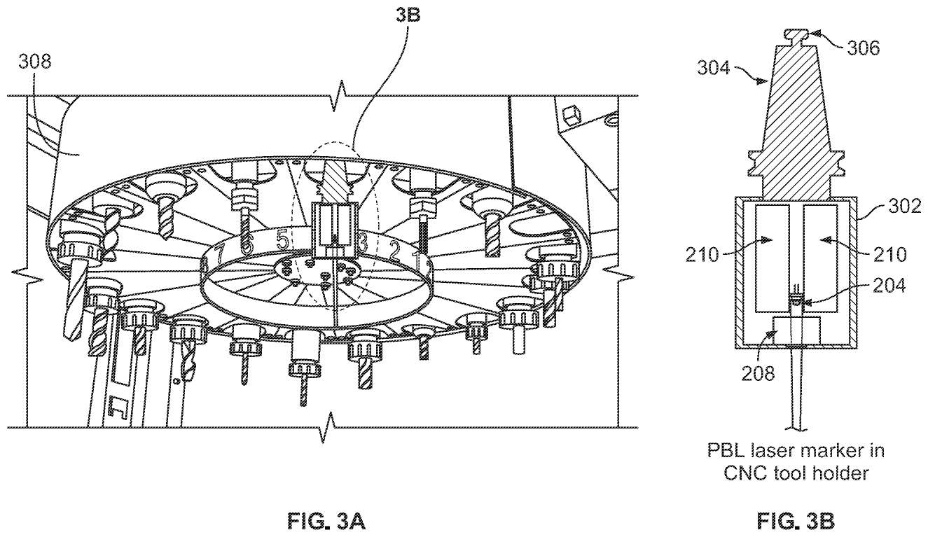

Referring now to FIG. 1, an exemplary system 100 comprising a tool (e.g. CNC tool) and a CNC machine is depicted. In this system 100, the CNC machine 300 comprises a CNC tool changer carousel 308 (see FIG. 3A) and spindle 310. A CNC tool 200, such as a laser marking tool or laser marker, is used in operation with the CNC machine 300. Particularly, the CNC tool 200 utilizes the CNC machine 300 to provide the precise motions needed for laser marking. More particularly, the CNC tool 200 can receive commands from the CNC machine 300 by sensing and interpreting the motions of one or more components of the CNC machine 300. In operation, the CNC tool 200 utilizes motion sensing in order to detect commands from the CNC machine 300. Accordingly, as will be discussed further below, the CNC tool 200 includes at least one sensor 206 adapted to interpret a predetermined motion of the CNC machine 300 as a command for the CNC tool 200 to perform a respective predetermined function.

Thus, CNC tool 200 can operate with various CNC machines, without the need for customization or integration, via a one-way communication from the CNC machine 300 to a CNC tool 200 attached to the CNC machine 300. The communication is characterized as “one-way” in that in operation, an active (compared to passive) CNC tool 200 requires input(s) from the CNC machine 300, such as start or stop signals from a controller of the CNC machine 300, for example, but the tool 200 does not necessarily communicate back any information to the CNC machine 300. Further, the “one-way” communication is performed wirelessly, because a wired connection to a CNC tool 200 is less practical due to movement of the CNC machine 300, components thereof, or other machines downstream/upstream the CNC machine 300. Still further, the communication may comprise standard G-codes, i.e. the industry programming language for CNC machines 300, or other suitable programming languages.

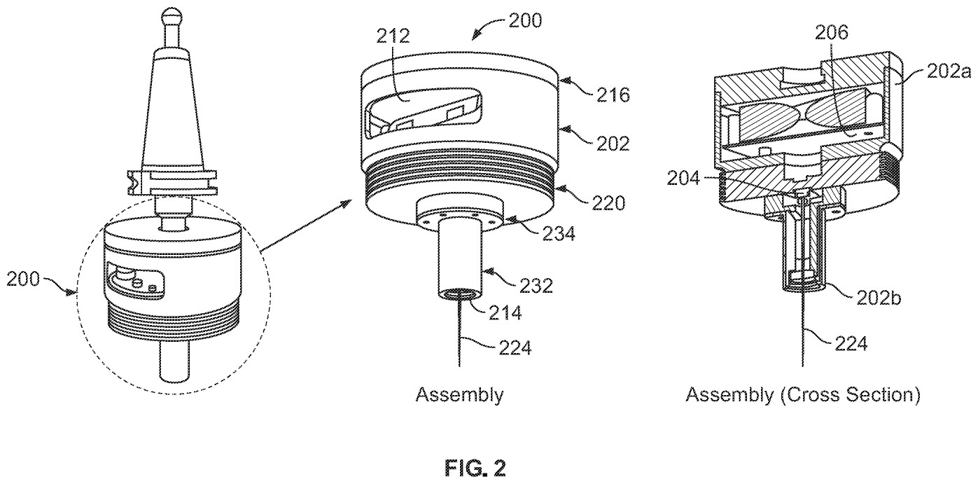

Turning now to FIGS. 2 and 3A-3B, an exemplary laser marking tool for use in a CNC machine is illustrated. In general, the CNC tool 200 includes a tool housing 202, a laser 204 and at least one sensor 206 disposed within the housing 202, and a power source 210 (e.g. a battery) coupled to the laser 204. In an exemplary embodiment, the tool housing 202 comprises a top end 202a and a bottom end 202b opposite the top end 202a. Between the two ends is a cavity 212, wherein the laser 204, at least one sensor 206, and power source 210 may be disposed. Light emitted from the laser diode 204 (e.g. laser beam path 224) travels through an opening 214 at the bottom end 202b of the tool housing 202. Additionally, or optionally, the bottom end 202b of housing 202 comprises an optical tube or cover 232 and/or an optical shield or mount 234 for protecting at least the laser diode 204 housed within. Still further, the wireless marking tool 200 may include one or more of a diode cap and a diode heat sink 220 for dissipating heat generated by the laser 204. In an exemplary embodiment, the CNC tool 200 is adapted to mark in gray scale.

In an exemplary embodiment, as illustrated in FIGS. 1, 2, and 3A-3B, in order to facilitate attachment of the CNC tool 200 with the CNC machine 300, a tool adapter 216 is connected to the top end 202a of the housing 202 for adapting the CNC tool 200 to the CNC machine 300. The tool adapter 216 is configured to engage with one or more components of CNC machine 300, such as the tool holder 302, tool carousel 308, and/or spindle 310. In an exemplary embodiment, the tool adapter 216 is integrally formed with the housing 202, such that for example, the tool adapter 216 extends from the top end 202a of the tool housing 202. Alternatively, the tool adapter 216 is a component separate from the housing 202, and may be attached or connected to the housing 202 (e.g. the top end 202a of the housing 202) by known attachment mechanisms (e.g. snap fit, adhesives, etc.). The tool holder 302 comprises an interchangeable machine taper 304 and/or an interchangeable pull stud 306 for connecting the CNC tool 200 to the CNC machine 300. The machine taper 304 and/or pull stud 306 may facilitate connection of the CNC tool 200 with a CNC tool changer carousel 308 and spindle 310. In one non-limiting example, the machine taper 304 may comprise a spindle taper for mounting in the CNC machine 300. In this way, the CNC tool 200 is self-contained within the CNC machine 300. In an exemplary embodiment, the CNC tool 200 can be stored in the tool carousel 308 of the CNC machine 300 and can thus be used or called upon by the CNC machine 300 without interruption or requiring additional fixturing or setup or moving time (necessary when using a separate laser marker machine). Additionally, or optionally, the CNC tool 200 with the CNC machine 300 includes a security feature, wherein the machined parts to be marked or engraved cannot be removed from the CNC machine 300 until after the laser marking operation. Finally, one skilled in the art would understand that the type, shape, size, and construction of the exemplary tool holder 302 are not limited to the illustrated holders 302.

The CNC tool changer carousel 308 may comprise a tool changer which include a series of tool holders 302 disposed relative to each other at predetermined intervals along a circumference of tool changer carousel 308. Thus, as the tool changer rotates in response to a command from a controller of the CNC machine 300, having wired connections is undesirable, particularly when the individual tool holders (and thus the CNC tools 200) are configured to spin or rotate at high speeds.

Importantly, the CNC tool 200 may have a laser 204 powered by a power source 210, such as a battery, which is preferable over a wired or corded laser since this wired or corded option would require modifications to at least the CNC tool changer carousel 308 and spindle 310. In an exemplary embodiment, the laser diode 204 may comprise a semiconductor laser. For example, the semiconductor laser is a continuous wave laser diode 204 having a wavelength of 390-470 nm and a power output of 1 W-5 W. Exemplary multi-watt blue semiconductor lasers 204 may include Metal Can® PLPT9 450LB_E Blue Laser Diode In TO90 Package, as designed by Osram Opto Semiconductors GmbH of Regensburg, Germany. Additionally, or optionally, the laser 204 may comprise a Q-switched, diode-pumped solid-state (DPSS) laser. In one non-limiting example, the DPSS laser has the following characteristics: a wavelength of 1064 nm, a pulse energy (or power output) in a range between 10-5000 mW, a pulse duration in a range between 0.1-100 ns, and a pulse repetition rate in a range between 0.1-100 kHz. Additionally, or optionally, the marking tool 200 includes one or more of a diode cap and a diode heat sink 220 for dissipating heat generated by the laser 204.

In an exemplary embodiment, the battery-operated laser 204 is sufficiently powerful to mark or engrave metals to form high resolution functional and/or aesthetic patterns. Further, the battery 210 is of sufficient energy and power capacity and density, such that the battery-operated laser 204 may be housed in a small enough package so it can be installed in a standard CNC tool holder 302 for laser marking. In an exemplary embodiment, battery 210 comprises a Li-ion battery cell having approximately 10 Whr capacity, such as Panasonic 18650 Li-ion 3180 mAh battery, as designed by Panasonic Energy Co. Ltd. of Japan.

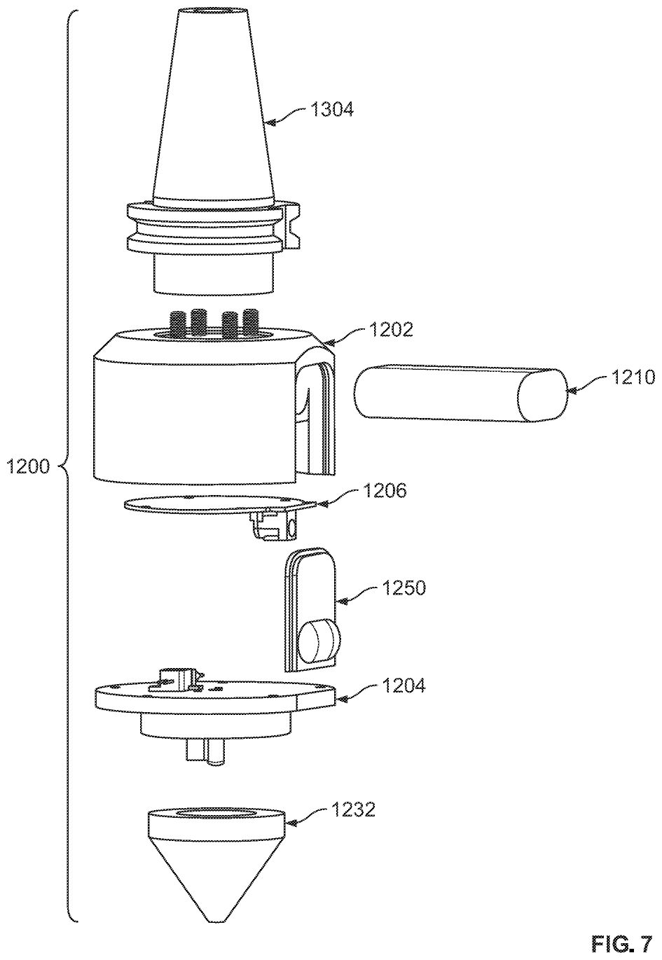

To facilitate further multiple use cycles of the CNC tool 200, the battery 210 may be removable, such as for facilitating battery replacement. Additionally, or optionally, the battery 210 is rechargeable, and the CNC tool 200 comprises a charging port 1250 (FIG. 7) for the battery 210 and/or means for wirelessly charging the battery 210. Notably, the rechargeable battery 210 may be charged while the CNC tool 200 is still attached to the CNC machine 300. Additionally, or optionally, the CNC tool 200 comprises built-in battery management. In an exemplary embodiment, the built-in battery management includes at least one of battery level information, a sleep mode, and a switching device. Further, at least one sensor 206 comprises another sensor for determining if the tool 200 is mounted the CNC machine 300, such that if the tool 200 is not mounted in the CNC machine 300, the tool 200 is powered off, and when the tool 200 is mounted in the CNC machine 300, the tool 200 is powered on. In this way, battery life may be extended or improved.

As best shown in FIGS. 1 and 2, the CNC tool 200 has at least one sensor 206. In an exemplary embodiment, the at least one senor 206 coupled to electronic circuitry of tool 200, is an inertial sensor. The inertial sensor includes, but is not limited to, an accelerometer and/or a gyroscope configured to detect acceleration or rotation caused by movement or motion of the CNC machine 300 or a component thereof (e.g. spindle 310). Thus, the predetermined motion of the spindle 310, for example, is interpreted by at least one sensor 206 as a command for CNC tool 200 to perform a respective predetermined function. Additionally, or optionally, the spindle 310 motions (interpreted by at least one sensor 206) include one or more of spindle 310 rotation speed, spindle 310 acceleration, and spindle 310 translation (Z motion). In another exemplary embodiment, the CNC tool 200 comprises a memory for storing at least one functional and/or aesthetic pattern for laser marking a workpiece. In this way, the respective predetermined function performed by the at least one sensor 206 may include powering the laser off/on, synchronizing the CNC tool 200, loading one of the patterns stored in the memory, and a combination thereof.

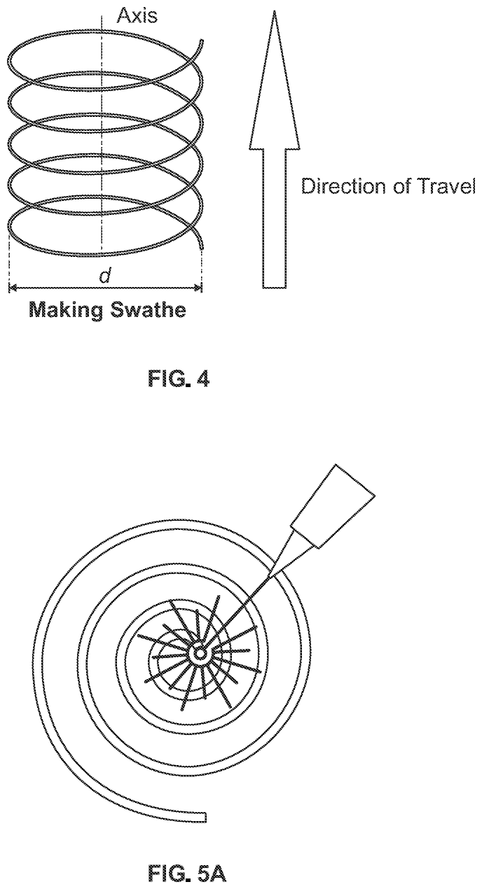

Referring now to FIGS. 2 and 4, specific details of the laser operation is disclosed. CNC tool 200 may comprise at least two operating modes, including but not limited to, off axis marking, vector marking, raster scan marking, and a combination thereof. One skilled in the art would understand that the laser 204 is pointed in-line with the Z axis. However, in off-axis marking (as shown in FIG. 4), the laser 204 is offset relative from the central rotation axis of the spindle 310 (FIG. 1), thereby giving an offset radius. The spindle 310 of the CNC machine 300 is thus rotated while the workpiece is moved in a linear direction. In an exemplary embodiment, the laser 204 is fired at predetermined intervals, which is synchronized to the rotation and motion of the CNC machine 300 (e.g. spindle 310). In this way, the laser 204 is configured to mark a swathe up to 2 times the offset radius, as the workpiece is moved across the path of the rotating laser 204.

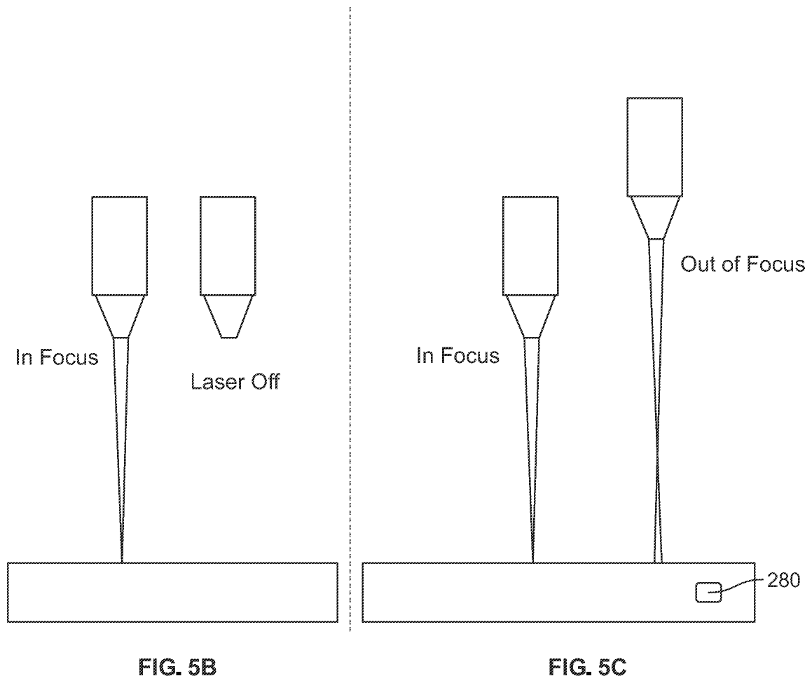

As shown in FIGS. 2 and 5A-5C, in vector marking, the laser 204 is switched ON and the workpiece is moved following a programmed contour of a length and a duration. The laser 204 is then switched OFF at the end of the contour (FIG. 5A). When moving from one feature to another feature and across areas that must not be marked, the tool 200 could be switched OFF and ON again (as illustrated in FIG. 5B) or moved vertically into a position where the laser 204 is de-focused (power density on target below marking threshold) (as illustrated in FIG. 5C). As will be discussed below, the communication device 208 of CNC tool 200 is in wireless communication with a movable inertial device 280 (shown in FIG. 5C) disposed on the CNC machine 300 (FIG. 1).

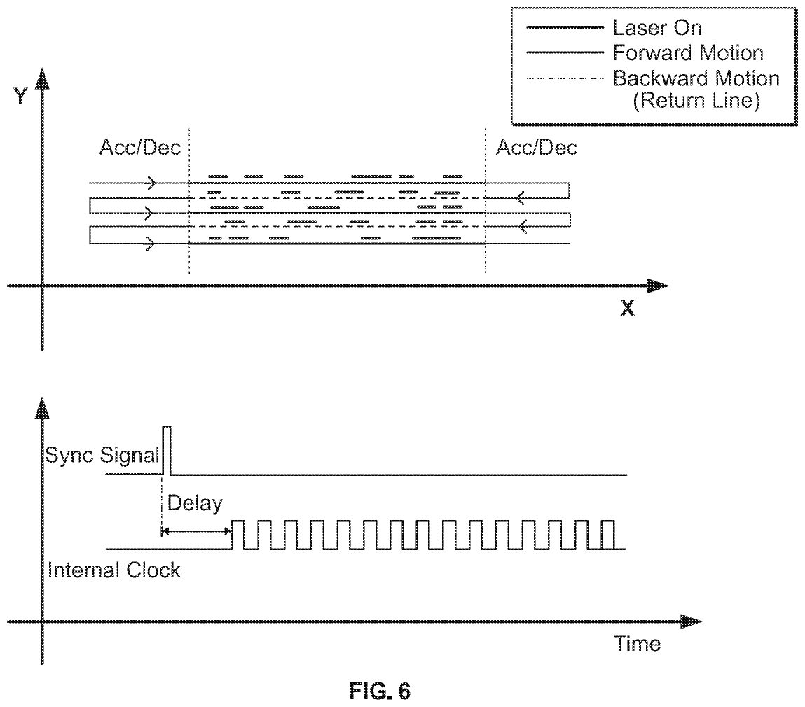

As shown in FIGS. 2 and 6, in raster scan marking, a 2D pattern is stored in the internal memory of the CNC tool 200. The pattern is organized in memory as a matrix (or as a monochrome image) with a given number of rows and columns (pixels). The pattern can be binary (on or off) or grayscale where each pixel encodes a variable laser power. In a non-limiting example, an 8bit per pixel can encode 256 laser power levels. The workpiece is moved at constant speed to entirely scan the area of the workpiece to be marked. At the beginning of each line, a synchronization signal is sent from the CNC machine 300 to the CNC tool 200. The marking tool 200 modulates the laser power (according to a predetermined pattern stored in local memory) at a predetermined rate using an internal clock. The internal clock is gated by the synchronization signal and delayed by a fixed programmed amount to allow the workpiece to reach constant speed. Raster scan marking can be unidirectional, whereby marking happens only on forward motions, or bi-directional, whereby marking is performed on both forward and backward directions. For bi-directional marking, the synchronization signals for forward and backward directions are tuned properly in order to avoid misalignments on the final marking formed on the workpiece.

As discussed above, a synchronization signal is required for operation of the CNC tool 200 based on motion of the CNC machine 300 or parts thereof. Thus, CNC tool 200 includes at least one sensor 206 configured to detect performance of a predetermined motion (rotation, translation, etc.) of the spindle 310. Then, the at least one sensor 206 is adapted to interpret this predetermined motion of the CNC machine 300 as a command for the CNC tool 200 to perform the respective predetermined function. A non-exhaustive list of commands (interpreted by at least one sensor 206) and corresponding motions for a CNC tool 200 is provided in Table 1 below.

TABLE 1
Commands and Corresponding Motions of Laser Marking Tool

| ID | Spindle motion and Z motion | Command |
|---|---|---|
| C1 | Counterclockwise rotation - low speed | Reset pattern to beginning - |
| | | laser off |
| C2 | 360° Clockwise rotation | Sync signal (start of line) |
| C3 | Counterclockwise rotation - fast speed | Laser on |
| C4 | Z translation up followed by spindle | Load next pattern |
| | 360° Counterclockwise rotation | |

Thus, in an exemplary operation of a unidirectional raster scan using the CNC tool 200 of the present invention, the user can implement the following sequence:
1. At beginning of each pattern, the spindle 310 is rotated counterclockwise (command C1 in Table 1 above) in order to reset the internal pointers to the beginning of the pattern.
2. The CNC stage (with a workpiece mounted thereon) is moved on the left of the upper left corner of the pattern.
3. Spindle rotated 360° Clockwise (command C2 in Table 1 above).
4. CNC stage is put in motion (x axis for instance) at constant speed for a distance larger than the pattern width, and the marker will start marking after some programmed delay.
5. CNC step Y axis.
6. CNC moves X back.
7. Loop to step #3.

The user can stop the marking between lines for inspection or other reasons, then the marking will restart at the right point once the next C2 command (Table 1) is sent.

The operation sequence described above is an exemplary process or method comprising steps that are performed sequentially in the order recited. However, it should be understood from the description herein that one or more steps may be omitted and/or performed out of the described sequence of the process while still achieving the desired result. Further, additional steps may be included within the operation sequence.

For vector marking, or for alignment reasons, the user may want to switch ON the laser 204 continuously using command C3 (Table 1). Then, the CNC stage can move following a contoured pattern. At the end of marking, the laser can be switched OFF using command C1 (Table 1). Because the beam may not be concentric to the spindle axis, a Z translation should be used to avoid a circular error in the resulting marking when using a rotational command. When moving from one feature to another features and across areas that must not be marked, the user can choose between the two operation modes described in FIGS. 5B and 5C. Additionally or optionally, a watchdog timer may switch the laser OFF after a programmable period of inactivity (e.g. no predetermined motion from spindle 310 detected by at least one sensor 3066).

A second embodiment of a CNC tool 200 for use in a CNC machine 300 according to the present invention is discussed below. The components of this embodiment, generally correspond to the first embodiment described above, with reference to FIGS. 1, 2, and 3A-3B. However, it differs in several respects. First, the CNC tool 200 includes a communication device 208 (FIG. 3B) disposed within housing 202 and in communication with the laser 204 for receiving further commands. Second, the communication device 208 is in wireless communication with a movable inertial device 280 (FIG. 5C) disposed on the CNC machine 300. In an exemplary embodiment, the movable inertial device 280 is attached to the CNC stage (whereon a workpiece may be placed). The movable inertial device 280 may be relatively small in size (e.g. as compared to the CNC stage or CNC machine 300), and may be magnetically attached in any position to a component of the CNC machine 300. Additionally, or optionally, the movable inertial device 280 is battery-powered, in a similar manner as described above with respect to powering the laser 204 or CNC tool 200. In general, wireless communication between movable inertial device 280 and CNC tool 200 having communication device 208, is via at least one of Bluetooth®, WiFi, and infrared (IR) technology. In operation, movable inertial device 280 can detect or sense the start of a line, recognizing the initial acceleration of the CNC stage and then triggering directly the CNC tool 200 using wireless communication. When not in use, the movable inertial device 280 can be easily detached and stored in a pocket on the CNC tool 200.

Finally, regarding safety features with respect to the embodiments discussed above, the CNC tool 200 is configured to be activated only when properly attached to the CNC machine 300, such that a user may not manually activate the laser 204. This will reduce or prevent the inherent risks correlated to any improper use of lasers 204. To achieve this, the laser 204 of the present disclosure can be triggered or activated (i.e., turned ON) only when the at least one sensor 206 detects the type of motions that may not be easily replicated manually. In a non-limiting example, translational movements/accelerations, which may result from mere handling of the CNC tool 200 or from mechanical shocks, are disregarded by the at least one sensor 206. Additionally, or optionally, the accelerometer 206 can be used to wake up the electronic circuitry or microcontroller of CNC tool 200, if the CNC tool 200 is in sleep mode or to initiate the interrupt service routine, but the gyroscope 206 can be read to perform a confirmatory function of measuring the rotational speed, in order to properly identify the command. A non-exhaustive list of properly interpreted commands are listed in Table 2 below.

TABLE 2
Proper Commands

| X and Y axes | | |
|---|---|---|
| measurements | Z axis measurement | RESULT |
| Acceleration on | Acceleration on the Z axis below a very | Proper |
| X and Y axes | small threshold (rotations along the Z | |
| above a given | axis always carries centrifugal | |
| threshold | accelerations on X and Y axes but not | |
| | on Z axis) | |
| Gyroscope readings | Gyroscope readings about Z axis above | Proper |
| about X and Y | a given threshold | |
| axes below a very | | |
| small threshold | | |

Referring to FIG. 7, another embodiment of a laser marking tool for use in a CNC machine is illustrated. The components of this embodiment, such as CNC tool 1200, generally correspond to the components of CNC tool 200, as described above. The CNC tool 1200 includes a tool housing 1202, a laser diode 1204 disposed within the housing 1202, at least one sensor 1206, and a power source 1210 (e.g. a battery). Additionally, or optionally, the CNC tool 1200 comprises an optical tube or cover, such as protective nozzle 1232, for protecting at least the laser diode 1204 housed within. Still further, in order to facilitate integration of the CNC tool 1200 with the CNC machine 300, the CNC machine 300 may comprise an interchangeable machine taper 1304 for connecting the CNC tool 1200 to the CNC machine 300, or components thereof, e.g. CNC tool changer carousel 308 (FIG. 3A) and spindle 310 (FIG. 1). To facilitate further multiple use cycles of the CNC tool 1200, the battery 1210 is rechargeable, and the CNC tool 1200 comprises a charging port 1250 for the battery 1210 and/or means for wirelessly charging the battery 1210.

Although the invention is illustrated and described herein with reference to specific embodiments, the invention is not intended to be limited to the details shown. Rather, various modifications may be made in the details within the scope and range of equivalents of the claims and without departing from the invention.

We claim:

1. A laser marking tool for use with a CNC machine, the tool comprising:
a housing;
a laser disposed within the housing;
at least one sensor disposed within the housing and adapted to interpret a predetermined motion of the CNC machine as a command for the tool to perform a respective predetermined function; and
a power source coupled to the laser.

2. The laser marking tool according to claim 1, wherein the at least one sensor includes an accelerometer or a gyroscope.

3. The laser marking tool according to claim 1, wherein the power source is a battery.

4. The laser marking tool according to claim 1, wherein the commands are based on spindle motions of the CNC machine.

5. The laser marking tool according to claim 4, wherein the spindle motions include one or more of spindle rotation speed, spindle acceleration, and spindle translation (Z motion).

6. The laser marking tool according to claim 1, further comprising a memory for storing at least one pattern for laser marking a workpiece.

7. The laser marking tool according to claim 6, wherein the predetermined function comprises one or more of: powering the laser off/on, synchronizing the laser marking tool, and loading one of the patterns stored in the memory.

8. The laser marking tool according to claim 1, further comprising:
a communication device disposed within the housing and in communication with the laser for receiving further commands, the communication device also being in wireless communication with a movable inertial device disposed on the CNC machine.
